(19) United States
(12) Patent Application Publication
(10) Pub. No.: US 2024/0221375 A1
(43) Pub. Date: Jul. 4, 2024

(54) TOKEN PRUNING IN SWIN TRANSFORMER ARCHITECTURES

(71) Applicant: Qatar Foundation for Education, Science and Community Development, Doha (QA)

(72) Inventors: David Yang, Ar-Rayyan (QA); Marwa Qaraqe, Ar-Rayyan (QA); Emrah Basaran, Ar-Rayyan (QA)

(21) Appl. No.: 18/400,635

(22) Filed: Dec. 29, 2023

Related U.S. Application Data
(60) Provisional application No. 63/435,923, filed on Dec. 29, 2022.

(51) Int. Cl. G06V 10/94; G06V 10/778

(52) U.S. Cl. CPC G06V 10/94; G06V 10/778

(57) ABSTRACT

Token pruning in Swin transformer architectures is provided via identifying initial windows into which the tokenized input to a Swin transformer architecture is divided and a pruning target; identifying D₁ tokens in each initial window, excluding those tokens located in a first row of each initial window, having a lowest information content; merging each of the D₁ tokens in each initial window into another token in that initial window in a vertical direction to transform each initial window into a corresponding intermediate window; identifying D₂ tokens in each intermediate window, excluding those tokens located in a first column of each intermediate window, having a lowest information content; merging each of the D₂ tokens in each intermediate window into another token in that intermediate window in a horizontal direction to transform each intermediate window into a corresponding spatially complete window.

### CROSS-REFERENCES TO RELATED APPLICATIONS

The present disclosure claims the benefit of U.S. Provisional Patent Application No. 63/435,923 entitled “SYSTEM AND METHODS FOR TOKEN PRUNING IN SWIN TRANSFORMER ARCHITECTURES” and filed on Dec. 29, 2022, which is incorporated herein by reference in its entirety.

### BACKGROUND

Deep learning methods have been applied to many machine learning problems, such as computer vision, image processing, and natural language processing. However, the high computational costs of many deep learning methods are a disadvantage, especially for edge devices. To overcome this issue, methods to reduce the computational costs by eliminating less important information include weight quantization, channel or layer pruning, and distillation.

However, due to the unique hierarchical structure of Swin transformer architectures, these methods are inapplicable. Accordingly, a need exists for a system and methods that reduce the computational costs of using a Swin transformer model applying deep learning methods and models to solve machine learning problems.

### SUMMARY

The present disclosure provides new and innovative systems and methods for token pruning in Swin transformer architectures. The present disclosure provides for a token pruning system containing a Swin transformer model that receives input data and processes the input data to obtain tokens.

A token pruning system may include a memory and a processor in communication with the memory, configured to receive input data into a Swin transformer model and process the received data using the Swin transformer model in order to obtain token. The token pruning module then performs a token pruning action on the tokens. This token pruning action may include such methods as token removing, token packaging, and token merging.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIGS. 1A-1C illustrate pruning and operation of non-Swin transformer models.

FIGS. 2A-2D illustrate pruning and operation of Swin transformer models, according to embodiments of the present disclosure.

FIGS. 3A-3D illustrate pruning methods for Swin transformer models of removing, packaging, and merging, according to embodiments of the present disclosure.

FIG. 4 illustrates accelerations when the system performs token pruning using the merging method in different layers of the Swin-Tiny model, according to embodiments of the present disclosure.

FIG. 5 illustrates an example system for token pruning, according to embodiments of the present disclosure.

FIG. 6 illustrates a computing device, according to embodiments of the present disclosure.

FIG. 7 is a flowchart for an example method of token pruning in Swin transformer architectures, according to embodiments of the present disclosure.

### DETAILED DESCRIPTION

The present disclosure provides new and innovative systems and methods for token pruning in Swin transformer architectures. A Swin Transformer is a transformer-based deep learning model used in vision tasks.

Following the success of transformer-based methods for natural language processing, many methods have been proposed in recent years to take advantage of transformers for computer vision as higher performance has been achieved compared to classical convolutional neural networks (CNN).

The most computationally intensive layers in transformers are the multi-head self attention (MHSA) layers. The main reason for this computational cost is the attention calculations performed between tokens. Therefore, different methods on token pruning have been proposed in recent studies. With the pruning methods proposed for vision transformers, the tokens corresponding to the image regions that do not contain information or have the least information are determined and removed from the attention calculations. The Swin transformer differs from standard transformers with by having a hierarchical architecture and localized attention calculations; rendering traditional pruning methodologies inapt. In the pruning methods proposed specifically for the Swin architecture, pruning operations should be handled differently from other methods by taking these features into account.

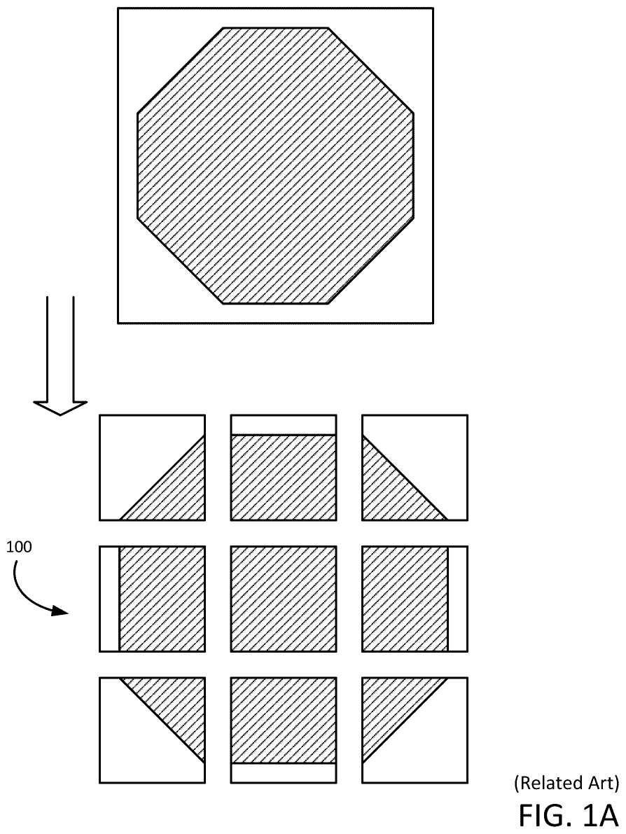

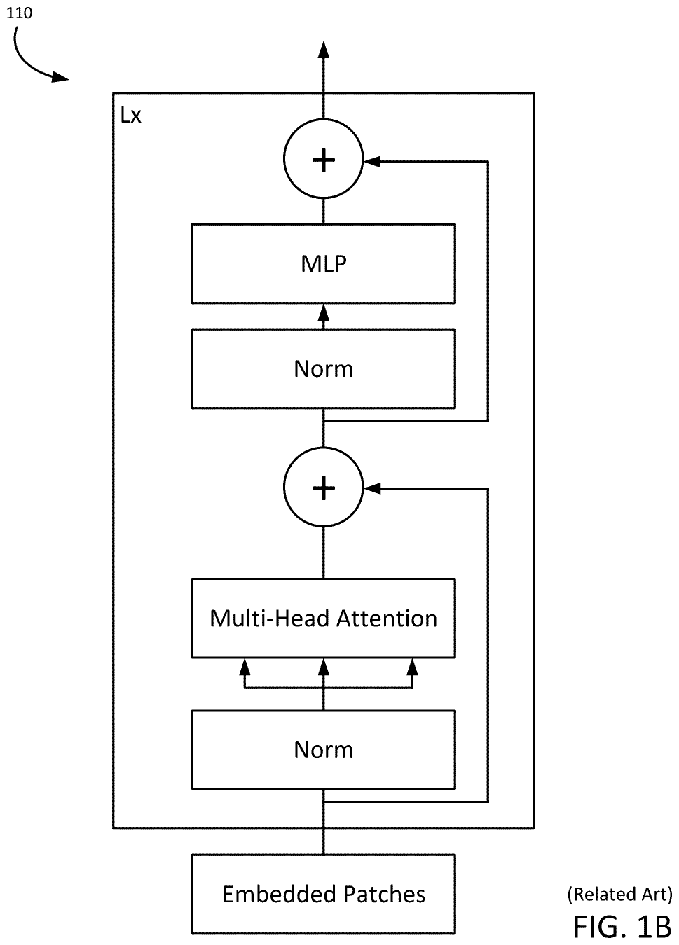

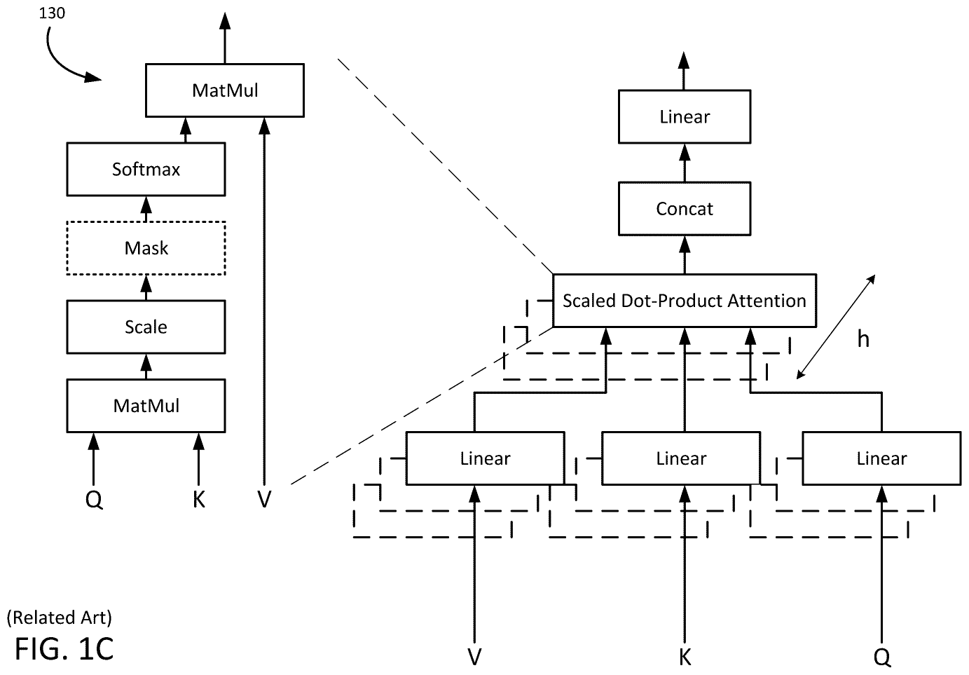

FIGS. 1A-1C illustrate pruning and operation of non-Swin transformer models. The first transformer in computer vision, Vision Transformer (ViT), was used for image classification. The inputs to the ViT model are image patches 100, which are defined in a non-overlapping manner, as shown in FIG. 1A. These patches 100 are flattened to create vectors containing the raw pixel values. The vectors are then projected to obtain the features which are called tokens, and the standard transformer encoder layers are fed with these tokens. FIG. 1B shows the internal structure 110 of a standard transformer encoder layer. As seen in the figures, the feature vectors (tokens) given as input to the encoder layer are first normalized and then passed to the MHSA layer. The output vectors of the MHSA are re-normalized and fed into the multi-layer perceptron (MLP) layer. As shown in FIG. 1B, there are two residual connections in the transformer encoder layer, one for MHSA and one for MLP.

Self-attention layers form the core of transformer architectures. The operations performed in a self-attention layer 120, as shown in FIG. 1C. First, three different representations are created for each token with linear projection layers; query (Q), key (K), and value (V). Then, by performing the QKT matrix multiplication, the similarity values between tokens are calculated and an attention matrix is created with these similarity values. In the next two layers, attention values are first scaled by dividing by a scalar and then row-wise softmax normalization is performed. Finally, the weighted averages are obtained by multiplying the attention matrix with the value (V). MHSA architecture is shown in FIG. 1C. The operations performed in the self-attention layer, called head, are executed in parallel in MHSA. The results obtained from each head are concatenated and projected. In traditional vision transformers, attention matrices are calculated globally between each patch, as shown in FIG. 1A. Therefore, these transformers have quadratic computational complexity to image size. Moreover, since the features are obtained from a single low resolution, these transformer models are not suitable for dense recognition tasks.

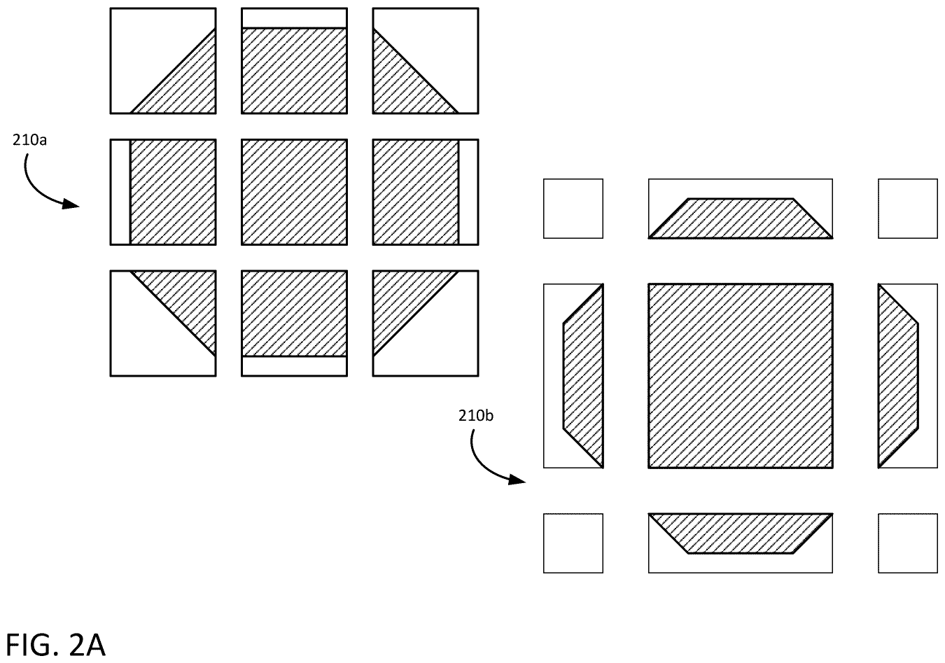

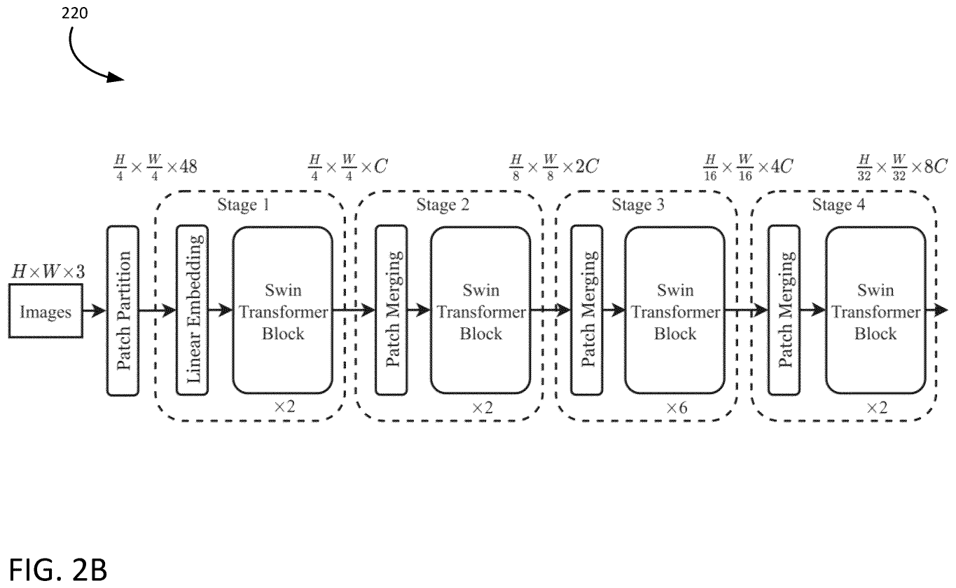

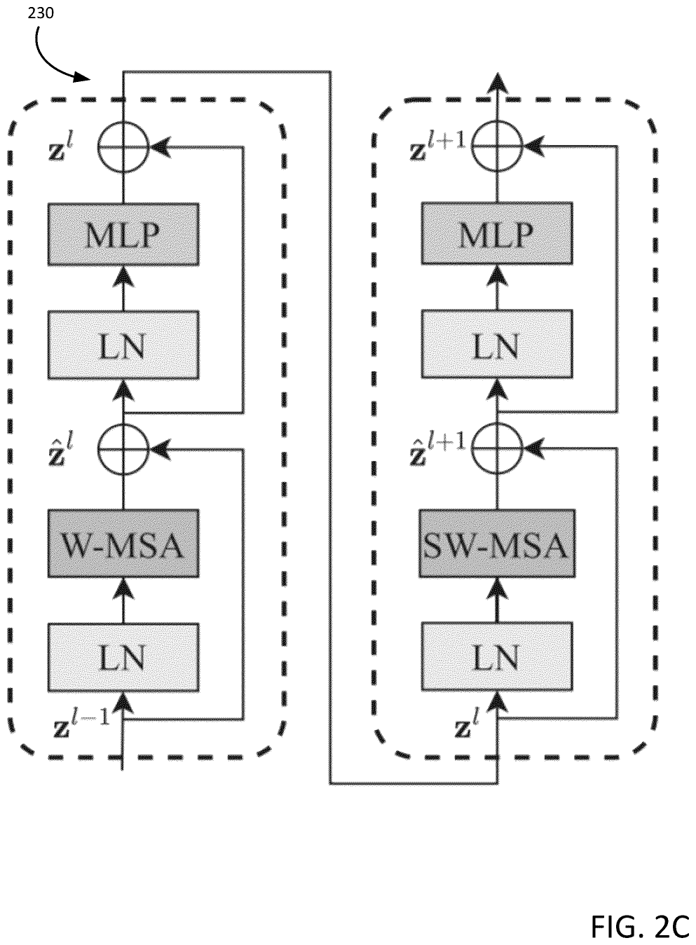

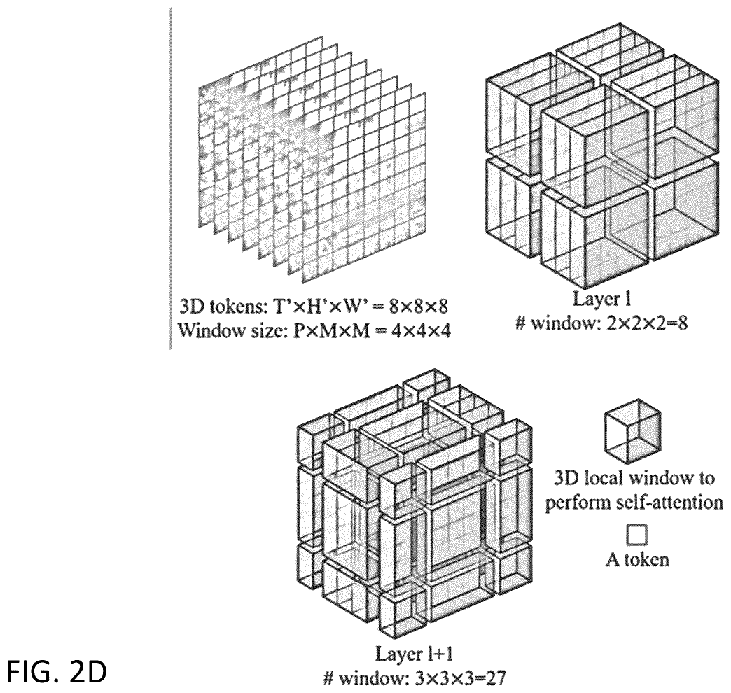

FIGS. 2A-2D illustrate pruning and operation of Swin transformer models, according to embodiments of the present disclosure. In Swin transformer architecture, unlike the other architectures, attention matrices are calculated within local windows. Since the number of patches in these windows is kept constant, a linear complexity is obtained to the image size. In the Swin transformer, the local attention matrices are calculated in two consecutive layers. FIG. 2A shows how the images are divided into local windows 200 in these layers. In the first layer 210a, the windows are determined to cover the entire image and not overlap. The windos determined in the second layer 210b are the shifted versions of the windows in the first layer 210a. In addition, a hierarchical feature descriptor is constructed by gradually merging patches in the following layers within the Swin transformer architecture. Therefore, Swin transformers have become a general backbone that can be used for dense recognition tasks such as object detection and semantic segmentation as well as image classification. The general structure of the Swin transformer architecture 220 is given in FIG. 2B. The internal structure of the layer in this architecture called Swin Transformer Block, where the attention matrices are calculated, is shown in FIG. 2C. Although primarily described in relation to a Swin transformer architecture 230 used for image-based tasks, the present disclosure also contemplates that a Video Swin transformer (taking into account the time dimension in which tokens are created in three dimensions and attention matrices are calculated in three-dimensional windows) may be improved via the described pruning operations. FIG. 2D shows three-dimensional tokens and window splitting for video data.

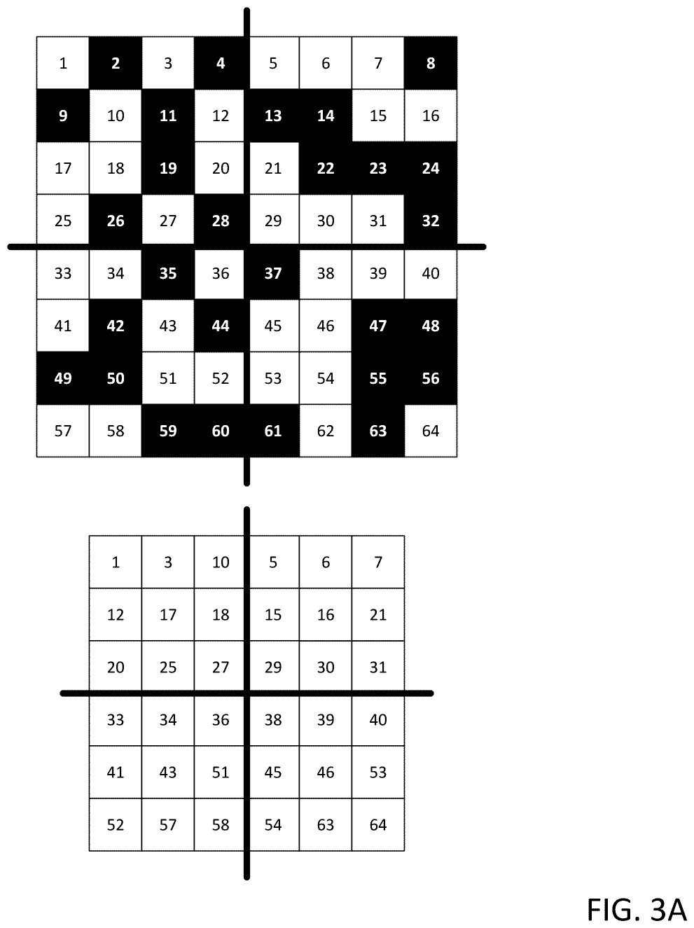

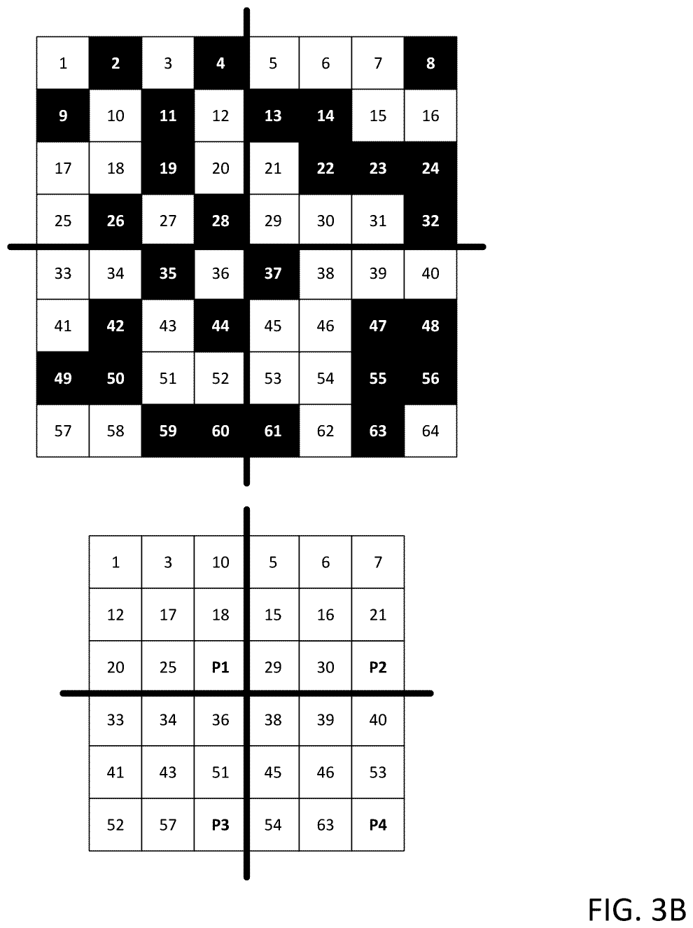

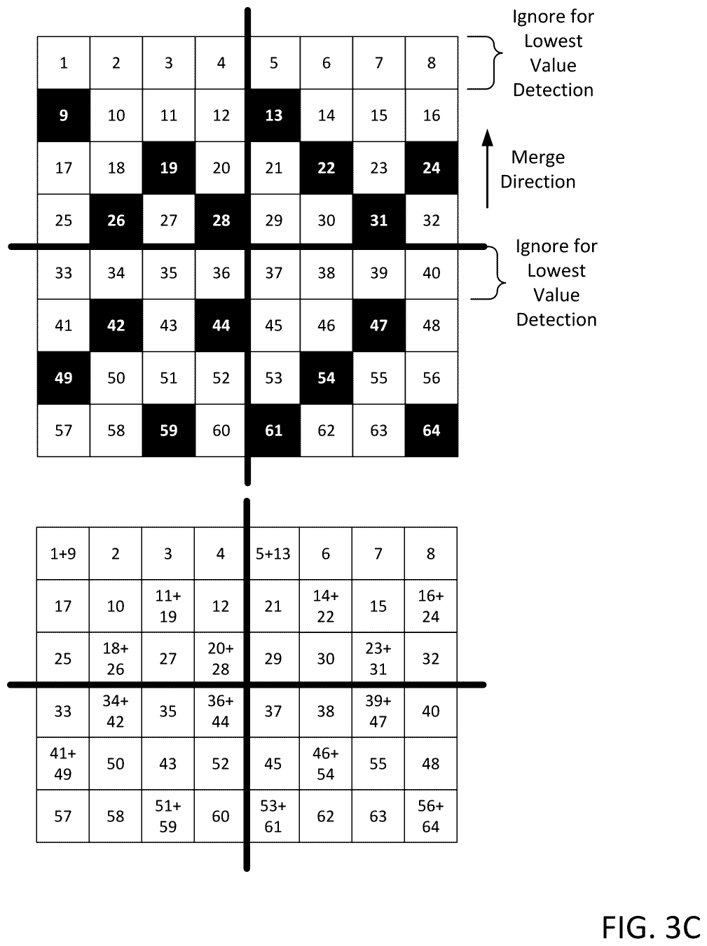

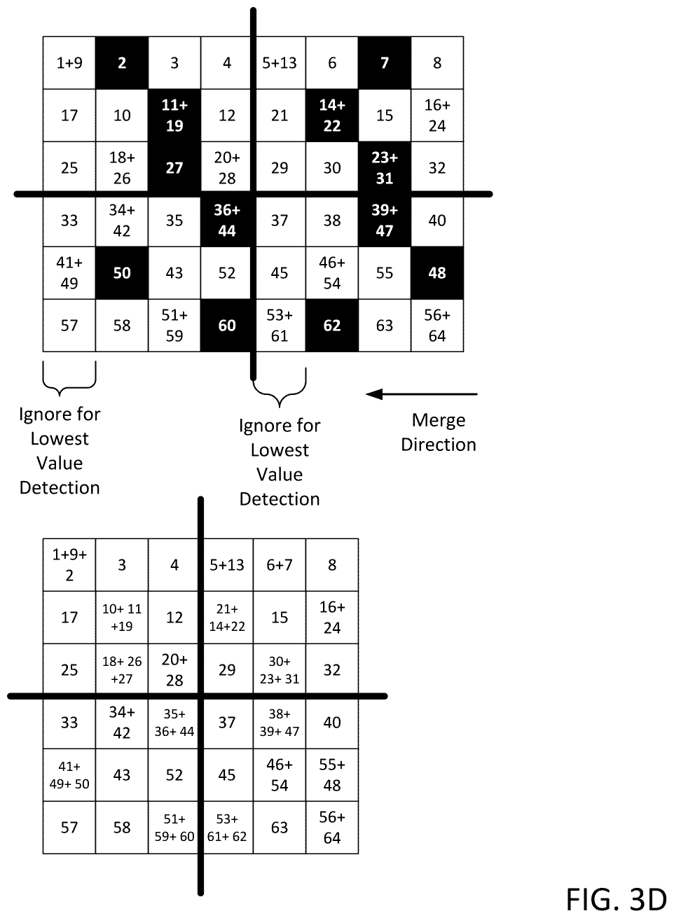

In ViT and similar transformer models, the token numbers and structure determined before the first transformer layer are preserved in the following layers. Therefore, the token pruning methods proposed for these models are not suitable for Swin transformers whose token numbers and structure change in a hierarchical manner. The present disclosure therefore contemplates, several pruning methods that can be used for both Image Swin and Video Swin architectures. These methods, called removing, packaging, and merging, and are respectively illustrated in FIGS. 3A-3C, according to embodiments of the present disclosure.

In the methods described herein, the pruning process is performed separately within each of the windows shown in FIG. 2A (or FIG. 2D). The system first estimates a score for tokens in each window using a score prediction module introduced. Then, the system prunes the tokens with the lowest scores within the windows. The score prediction module can be added before any Swin transformer layer and the tokens in that layer are pruned. In the training phase, the added score prediction modules are trained for a certain number of iterations. Then, the whole network is trained end-to-end.

In each of FIGS. 3A-3C, a tokenized input data set 310 is shown divided into a series of four initial windows that are 4×4 in size (e.g., K=4; A=K×K=16), and a pruning target has been set to produce an output data set divided into spatially finalized windows that are 3×3 in size (e.g., K=3; A=K×K=9). Each token is shown with an index number beginning at 1 and terminating at 64 in a left-to-right/top-to-bottom indexing order with the indicated number of “lowest information” cells for each example designated with black background and white text. The present disclosure contemplates that different indexing schemes, different input/output data set size, different window sizes and number, and combinations thereof can be used with the pruning methodologies described herein. Stated differently, the illustration are provided as non-limiting examples,

Token removing is illustrated in FIG. 3A. In a window containing KxK tokens, the number of tokens to be pruned is determined so that (K−1)×(K−1) tokens remain in the window while keeping the square structure. Therefore, in each window, tokens are ranked according to respective scores and the K×K−(K−1)×(K−1)=2K−1 tokens with the lowest scores are removed.

Token packaging is illustrated in FIG. 3B. Even if the predicted score for any token were low, this token is likely to contain information about the image. Therefore, instead of removing tokens, the present disclosure re-packages these tokens and creates a new token. Tokens with low scores are weight-averaged with corresponding scores to create the token package for each window, shown in FIG. 3B as P1-P4, respectively.

In token removing and token packaging methods, the arrangement of tokens changes in each window, as shown in FIGS. 3A and 3B. Therefore, in the patch merging layers of the Swin transformer, which come after the pruning layer, tokens that are not structurally related to each other are merged.

In the token merging method, pruning is performed in a different way than the other two methods, without disturbing the structural relationship of the tokens within the windows as much as possible. This effect is achieved through a two-step pruning strategy, as shown in FIGS. 3C and 3D. In the first operation, shown in FIG. 3C, within each window, the tokens with the lowest scores, except the first row, are merged with the neighboring token in another row in a merge direction. In the second operation, shown in FIG. 3D, in the same way, the tokens with the lowest scores, except the first column, are merged with the neighboring tokens in the merge direction. Although shown with the indexes of the merged tokens added together for ease of reading across the operations, the merging of tokens is performed by weighted averaging with scores. With the token merging method, the neighborhood of tokens within the windows is preserved as much as possible; shifting non-merged tokens into the spaces vacated by the merged tokens.

In the Video Swin model, unlike Image Swin, windows are created in three dimensions, taking into account the temporal dimension. Therefore, while the introduced pruning methods are shown as applied with Image Swin, on Video Swin, pruning is performed separately for each frame in the window. Then, the attention matrix is calculated between the remaining tokens of the frames.

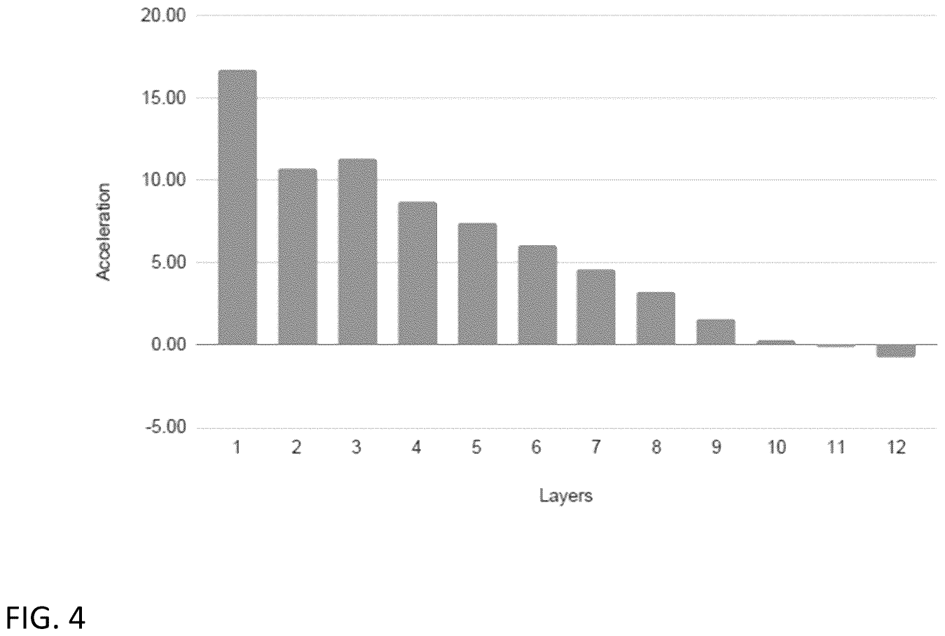

Despite the loss of information due to the removal of tokens in the pruning methods, the pruned data performs better; allowing for faster analysis. Experimentally, in all layers, the merging method was noted to perform better than the others. Especially in the first layers, there is a large difference between the merging method and the others. These results demonstrate that merging adjacent tokens provides a significant advantage. In FIG. 4, accelerations are shown when the system performs token pruning using the merging method in different layers of the Swin-Tiny model, according to embodiments of the present disclosure. The system measures the accelerations by computing the improvements in throughput (images/second). Experimentally, the batch size for the illustrated experiment was to 256. As expected, more acceleration is achieved in the first layers, while acceleration decreases towards the last layers and negative values are observed, since the cost of pruning is greater than the acceleration.

Due to the hierarchical and local self-attention mechanisms, the Swin transformer architecture has own unique characteristics that are unlike other vision transformer architectures. Therefore, token pruning methods proposed for other standard vision transformer models cannot be directly used for Swin transformers.

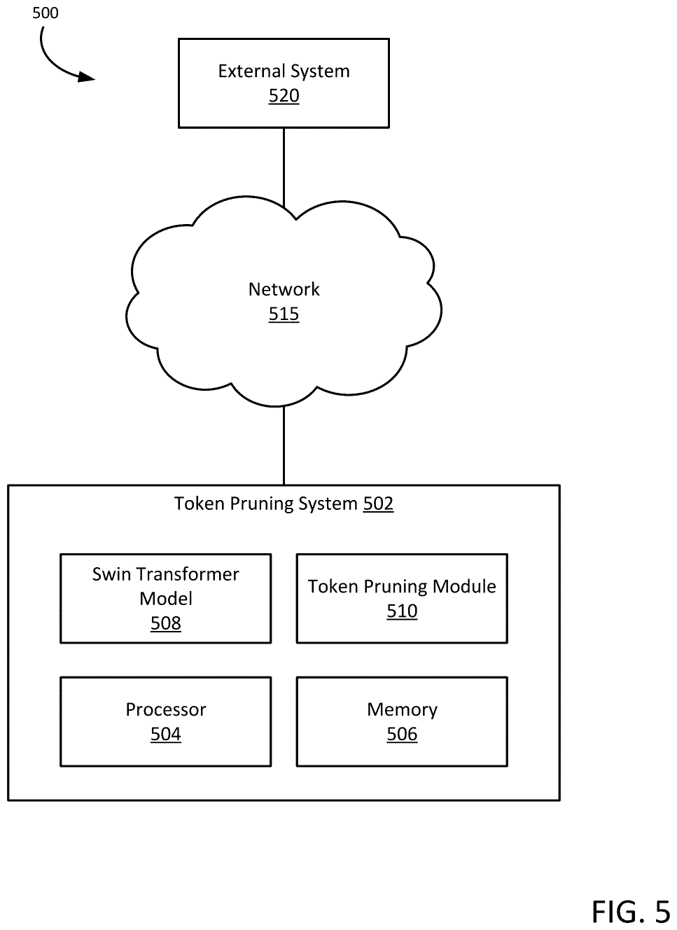

FIG. 5 illustrates an example system 500 for token pruning in Swin transformer architectures. The system 500 may include a token pruning system 502. In various aspects, the token pruning system 502 may include a processor 504 in communication with a memory 506. The processor 504 may be a CPU, an ASIC, or any other similar device. The token pruning system 502 may include a Swin transformer model 508. The Swin transformer model 508 receives input data, for example video or image data, which the Swin transformer model 508 then processes to obtain tokens. The Swin transformer model 508 may include a Swin transformer deep learning artificial neural network. A token pruning module 510 prunes the tokens by performing a token pruning action. This token pruning action may include such methods as token removing, token packaging, and token merging.

The token pruning system 502 may be in communication with an external system 520 over a network 515. The network 515 can include, for example, the Internet or some other data network, including, but not limited to, any suitable wide area network or local area network. For example, the external system 520 may include various client devices that access the token pruning system 502 over the network 515, such that token pruning system 502 is deployed as a cloud-based application or service.

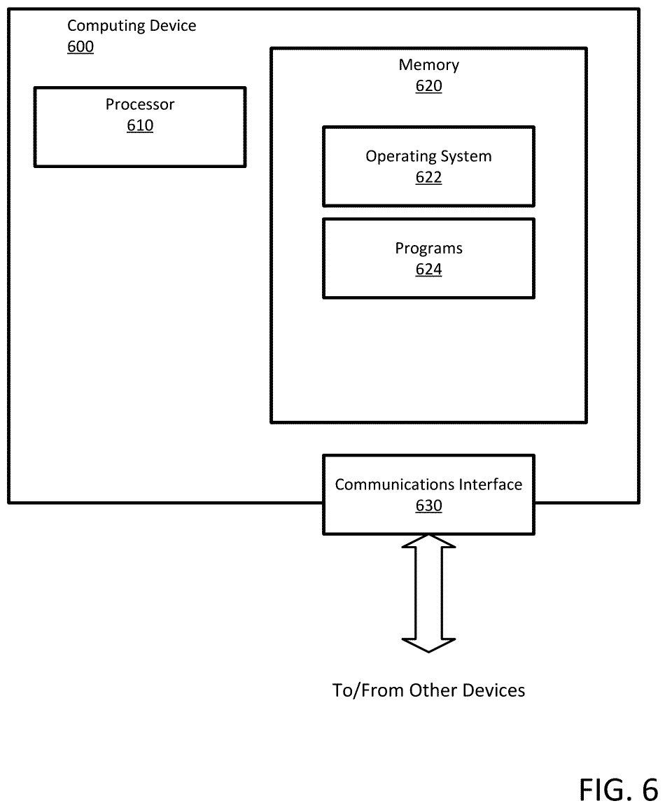

FIG. 6 illustrates a computing device 600, as may be used as the token pruning system 502 or represent an external system 520, according to embodiments of the present disclosure. The computing device 600 may include at least one processor 610, a memory 620, and a communication interface 630.

The processor 610 may be any processing unit capable of performing the operations and procedures described in the present disclosure. In various embodiments, the processor 610 can represent a single processor, multiple processors, a processor with multiple cores, and combinations thereof.

The memory 620 is an apparatus that may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As used herein, the memory 620 is an example of a device that includes computer-readable storage media, and is not to be interpreted as transmission media or signals per se.

As shown, the memory 620 includes various instructions that are executable by the processor 610 to provide an operating system 622 to manage various features of the computing device 600 and one or more programs 624 to provide various functionalities to users of the computing device 600, which include one or more of the features and functionalities described in the present disclosure. One of ordinary skill in the relevant art will recognize that different approaches can be taken in selecting or designing a program 624 to perform the operations described herein, including choice of programming language, the operating system 622 used by the computing device 600, and the architecture of the processor 610 and memory 620. Accordingly, the person of ordinary skill in the relevant art will be able to select or design an appropriate program 624 based on the details provided in the present disclosure.

The communication interface 630 facilitates communications between the computing device 600 and other devices, which may also be computing devices as described in relation to FIG. 6. In various embodiments, the communication interface 630 includes antennas for wireless communications and various wired communication ports. The computing device 600 may also include or be in communication, via the communication interface 630, one or more input devices (e.g., a keyboard, mouse, pen, touch input device, etc.) and one or more output devices (e.g., a display, speakers, a printer, etc.).

Although not explicitly shown in FIG. 6, it should be recognized that the computing device 600 may be connected to one or more public and/or private networks via appropriate network connections via the communication interface 630. It will also be recognized that software instructions may also be loaded into a non-transitory computer readable medium, such as the memory 620, from an appropriate storage medium or via wired or wireless means.

Accordingly, the computing device 600 is an example of a system that includes a processor 610 and a memory 620 that includes instructions that (when executed by the processor 610) perform various embodiments of the present disclosure. Similarly, the memory 620 is an apparatus that includes instructions that, when executed by a processor 610, perform various embodiments of the present disclosure.

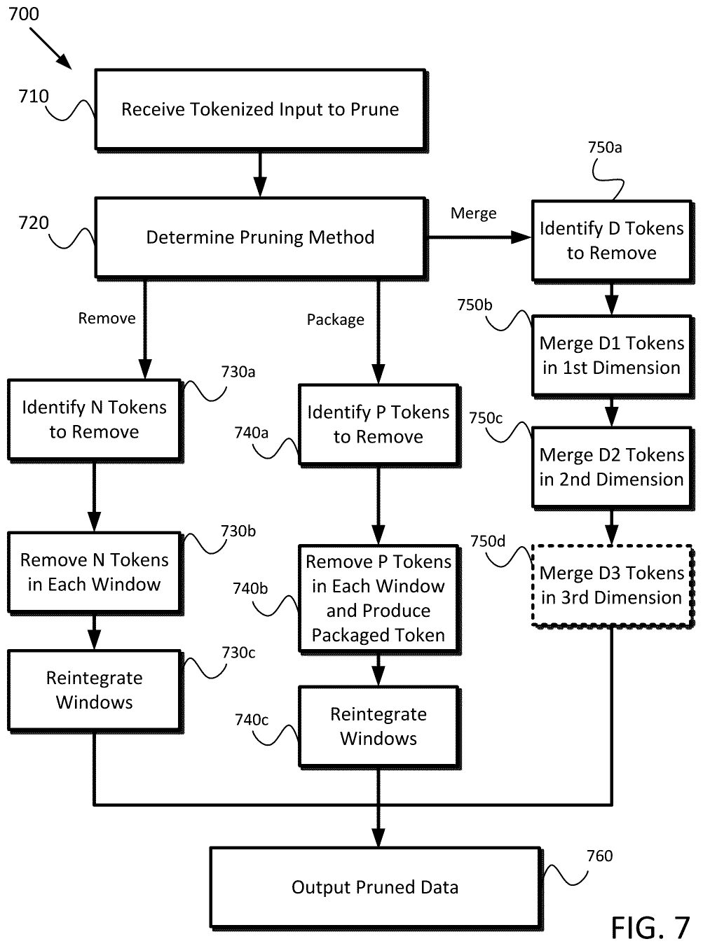

FIG. 7 is a flowchart for an example method 700 of token pruning in Swin transformer architectures, according to embodiments of the present disclosure. Method 700 begins at block 710, where the system receives a tokenized input to prune. In various embodiments, the Swin transformer may receive image data or video data as inputs, which the transformer process to obtain a plurality of tokens, which are provided to prune.

At block 720, the system determines whether to remove, package, or merge the tokenized input for the pruning method, and a pruning target.

At block 730a, when the system determines to remove tokens for the pruning method (per block 720), the system identifies windows of K×K tokens into which the tokenized input is divided and identifies how many tokens (N) to remove to achieved the pruning target. For example, to achieve a pruning target that updates the window from being 4×4 in size (e.g., K₀=4) to be 3×3 in size (e.g., K₁=3), the system identifies N=5 (e.g., 4×4=16; 3×3=9, K₀-K₁=N=5).

At block 730b, the system identifies a number of tokens (N) in each window sufficient to achieve the pruning target that have the N lowest values (e.g., the least information) in the respective window, and removes those N tokens from each window.

At block 730c, the system reintegrates the each of the windows from the remaining tokens. In various embodiments, the system maintains relative order of each remaining token relative to the initial order, which may be different than a relative order in the total (non-windowed) tokenized input.

At block 740a, when the system determines to package tokens for the pruning method (per block 720), the system identifies windows of KxK tokens into which the tokenized input is divided and identifies how many tokens (P) to package to achieved the pruning target. For example, to achieve a pruning target, P is one more than the difference between the size of the pre-pruned and post-pruned windows so that an original 4×4 window (e.g., K₀=4) pruned to be 3×3 in size (e.g., K₁=3), the system would identify P=6, where (e.g., 4×4=16; 3×3=9, K₀−K₁+1=P=6).

At block 740b, the system identifies a number of tokens (P) in each window sufficient to achieve the pruning ratio that have the P lowest values (e.g., the least information) in the respective window, and removes those P tokens from each window and produces a new “packaged token” from the removed tokens.

At block 740c, the system reintegrates the windows from the remaining tokens and the packaged token. In various embodiments, the system maintains relative order of each remaining token relative to the initial order, which may be different than a relative order in the total (non-windowed) tokenized input and places the “packaged token” in a last position in the window. In some embodiments, the “packaged token” may be placed at a relative position in the window based on a weighted average position of the positions of the removed tokens, or some other position in the window.

At block 750a, when the system determines to merge tokens for the pruning method (per block 720), the system identifies windows into which the tokenized input is divided and identifies how many tokens (D₁, D₂, D₃) to remove to in each dimension to achieved the pruning target. When performing pruning on still images, the system determines D₁ and D₂, and for video, determines D₁, D₂, and D₃. For example, to achieve a pruning target that updates the window from being 4×4 in size (e.g., K₀=4; K₀×K₀=A₀=16) to be 3×3 in size (e.g., K₁=3; K₁×K₁=A₁=9), the system identifies D₁=4 (e.g., 4×4=16=A₀; 4×3=12=A₁, A₀−A₁=D₁=4) and D₂=3 (e.g., 4×3=12=A₁; 3×3=9=A₂; A₁−A₂=3=D₂).

At block 750b, the system identifies a number of tokens (D₁) in each window sufficient to achieve the pruning ratio in a first dimension. The D₁ tokens have the lowest values (e.g., the least information) in the respective window K₀×K₀, and the system merges those D₁ tokens from each window into a neighboring token. In various embodiments, neighboring token is selected in a single direction (e.g., “above”) in a matrix defined by the window, and the system ignores the row of tokens in the extreme direction, as there is no token in the window that lies further in that single direction. For example, when merging cells “upward”, tokens in an uppermost row of the window may be ignored when identifying the D₁ tokens with the least information.

At block 750c, the system identifies a number of tokens (D₂) in each window after the merge operation per block 750b sufficient to achieve the pruning ratio in a second dimension. The D₂ tokens have the lowest values (e.g., the least information) in the respective window as updated K₀×K₁), and the system merges those D₂ tokens from each window into a neighboring token, in a different direction than in block 750b. In various embodiments, neighboring token is selected in a single direction (e.g., “leftward”) in a matrix defined by the window, and the system ignores the column of tokens in the extreme direction, as there is no token in the window that lies further in that single direction. For example, when merging cells “leftward”, tokens in a leftmost column of the window may be ignored when identifying the D₂ tokens with the least information.

At block 750d, if operating with video information, the system identifies a number of tokens (D₃) in each window after the merge operation per block 750c sufficient to achieve the pruning ratio in a third dimension. The Dstokens have the lowest values (e.g., the least information) in the respective window as updated (e.g., K₁×K₁×K₀), and the system merges those D₃ tokens from each window into a neighboring token, in a different direction than in block 750b and block 750c. In various embodiments, neighboring token is selected in a single direction (e.g., “before”) in a matrix defined by the window, and the system ignores the column of tokens in the extreme direction, as there is no token in the window that lies further in that single direction. For example, when merging cells “forward” in time, tokens in a latest plane of the window may be ignored when identifying the D₃ tokens with the least information.

Although described in relation to performing actions with respect to various rows, columns, and planes in block 750b, block 750c, and (optionally) block 750d, the present disclosure contemplates that horizontal, vertical, and temporal operations may be swapped in order.

At block 760, the system outputs the pruned data.

The present disclosure may also be understood with reference to the following numbered clauses:

Clause 1: A method including a plurality of operation; a system including a processor and a memory, storing instructions that, when executed by the processor, perform operations; or a non-transitory computer readable storage device, including instructions that, when executed by a processor, perform operations, wherein the operations include: receiving input data into a Swin transformer model; processing the input data in the Swin transformer model to obtain tokens for a tokenized input; selecting a pruning method for the input data from: removing; packaging; and merging; pruning the tokens using a token pruning module, which performs the selected token pruning method; and outputting pruned data.

Clause 2: The method, system, or device of any of clauses 1 and 3-7, wherein the selected pruning method is removing, and removing comprises: identifying windows into which the tokenized input is divided and a pruning target; identifying N tokens in each window having a lowest information content, where an area of each window is N greater than an area for each window to meet the pruning target; removing the N tokens from each window to achieve the pruning target with remaining tokens in each window; and reintegrating each of the windows from the remaining tokens therein.

Clause 3: The method, system, or device of any of clauses 1-2 and 4-7, wherein the reintegrated window maintains a relative order of the remaining tokens in each window from before pruning to after pruning.

Clause 4: The method, system, or device of any of clauses 1-3 and 5-7, wherein the selected pruning method is packaging, and packaging comprises: identifying windows into which the tokenized input is divided and a pruning target; identifying P tokens in each window having a lowest information content, where an area of each window is P−1 greater than an area for each window to meet the pruning target; removing the P tokens from each window; combining the P removed tokens to produce a packaged token for each window from the P removed tokens from that window; and reintegrating each of the windows from remaining tokens therein and the packaged token.

Clause 5: The method, system, or device of any of clauses 1-4 and 6-7, wherein the packaged token is reintegrated into the each of the windows in a shared location across the windows.

Clause 6: The method, system, or device of any of clauses 1-5 and 7, wherein the selected pruning method is merging, and merging comprises: identifying initial windows into which the tokenized input is divided and a pruning target; identifying D₁ tokens in each initial window, excluding those tokens located in a first row of each initial window, having a lowest information content; merging each of the D₁ tokens in each initial window into another token in that initial window in a vertical direction to transform each initial window into a corresponding intermediate window having a height that is D₁ smaller than a height of the initial window; identifying D₂ tokens in each intermediate window, excluding those tokens located in a first column of each intermediate window, having a lowest information content; merging each of the D₂ tokens in each intermediate window into another token in that intermediate window in a horizontal direction to transform each intermediate window into a corresponding spatially complete window having a width that is D₂ smaller than a width of the initial window and the intermediate window.

Clause 7: The method, system, or device of any of clauses 1-6, further comprising: identifying D₃ tokens in each spatially complete window, excluding those tokens located in a first temporal plane of each spatially complete window, having a lowest information content; merging each of the D₃ tokens in each spatially complete window into another token in that spatially complete window in a temporal direction to transform each spatially complete window into a tempo-spatially complete window having a time that is D₃ shorter than a time of the initial window, the intermediate window, and the spatially complete window.

Certain terms are used throughout the description and claims to refer to particular features or components. As one skilled in the art will appreciate, different persons may refer to the same feature or component by different names. This document does not intend to distinguish between components or features that differ in name but not function.

As used herein, the term “optimize” and variations thereof, is used in a sense understood by data scientists to refer to actions taken for continual improvement of a system relative to a goal. An optimized value will be understood to represent “near-best” value for a given reward framework, which may oscillate around a local maximum or a global maximum for a “best” value or set of values, which may change as the goal changes or as input conditions change. Accordingly, an optimal solution for a first goal at a given time may be suboptimal for a second goal at that time or suboptimal for the first goal at a later time.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

The invention is claimed as follows:

1. A method, comprising:
receiving input data into a Swin transformer model;
processing the input data in the Swin transformer model to obtain tokens for a tokenized input;
selecting a pruning method for the input data from:
removing;
packaging; and
merging;
pruning the tokens using a token pruning module, which performs the selected token pruning method; and
outputting pruned data.

2. The method of claim 1, wherein the selected pruning method is removing, and removing comprises:
identifying windows into which the tokenized input is divided and a pruning target;
identifying N tokens in each window having a lowest information content, where an area of each window is N greater than an area for each window to meet the pruning target;
removing the N tokens from each window to achieve the pruning target with remaining tokens in each window; and
reintegrating each of the windows from the remaining tokens therein.

3. The method of claim 2, wherein the reintegrated window maintains a relative order of the remaining tokens in each window from before pruning to after pruning.

4. The method of claim 1, wherein the selected pruning method is packaging, and packaging comprises:
identifying windows into which the tokenized input is divided and a pruning target;
identifying P tokens in each window having a lowest information content, where an area of each window is P−1 greater than an area for each window to meet the pruning target;
removing the P tokens from each window;
combining the P removed tokens to produce a packaged token for each window from the P removed tokens from that window; and
reintegrating each of the windows from remaining tokens therein and the packaged token.

5. The method of claim 4, wherein the packaged token is reintegrated into the each of the windows in a shared location across the windows.

6. The method of claim 1, wherein the selected pruning method is merging, and merging comprises:
identifying initial windows into which the tokenized input is divided and a pruning target;
identifying D₁ tokens in each initial window, excluding those tokens located in a first row of each initial window, having a lowest information content;
merging each of the D₁ tokens in each initial window into another token in that initial window in a vertical direction to transform each initial window into a corresponding intermediate window having a height that is D₁ smaller than a height of the initial window;
identifying D₂ tokens in each intermediate window, excluding those tokens located in a first column of each intermediate window, having a lowest information content;
merging each of the D₂ tokens in each intermediate window into another token in that intermediate window in a horizontal direction to transform each intermediate window into a corresponding spatially complete window having a width that is D₂ smaller than a width of the initial window and the intermediate window.

7. The method of claim 6, further comprising:
identifying D₃ tokens in each spatially complete window, excluding those tokens located in a first temporal plane of each spatially complete window, having a lowest information content;
merging each of the D₃ tokens in each spatially complete window into another token in that spatially complete window in a temporal direction to transform each spatially complete window into a tempo-spatially complete window having a time that is D₃ shorter than a time of the initial window, the intermediate window, and the spatially complete window.

8. A system, comprising:
a processor; and
a memory, storing instructions that, when executed by the processor, perform operations that include:
receiving input data into a Swin transformer model;
processing the input data in the Swin transformer model to obtain tokens for a tokenized input;
selecting a pruning method for the input data from:
removing;
packaging; and
merging;
pruning the tokens using a token pruning module, which performs the selected token pruning method; and
outputting pruned data.

9. The system of claim 8, wherein the selected pruning method is removing, and removing comprises:
identifying windows into which the tokenized input is divided and a pruning target;
identifying N tokens in each window having a lowest information content, where an area of each window is N greater than an area for each window to meet the pruning target;
removing the N tokens from each window to achieve the pruning target with remaining tokens in each window; and
reintegrating each of the windows from the remaining tokens therein.

10. The system of claim 9, wherein the reintegrated window maintains a relative order of the remaining tokens in each window from before pruning to after pruning.

11. The system of claim 8, wherein the selected pruning method is packaging, and packaging comprises:
identifying windows into which the tokenized input is divided and a pruning target;
identifying P tokens in each window having a lowest information content, where an area of each window is P−1 greater than an area for each window to meet the pruning target;
removing the P tokens from each window;
combining the P removed tokens to produce a packaged token for each window from the P removed tokens from that window; and
reintegrating each of the windows from remaining tokens therein and the packaged token.

12. The system of claim 11, wherein the packaged token is reintegrated into the each of the windows in a shared location across the windows.

13. The system of claim 8, wherein the selected pruning method is merging, and merging comprises:
identifying initial windows into which the tokenized input is divided and a pruning target;
identifying D₁ tokens in each initial window, excluding those tokens located in a first row of each initial window, having a lowest information content;
merging each of the D₁ tokens in each initial window into another token in that initial window in a vertical direction to transform each initial window into a corresponding intermediate window having a height that is D₁ smaller than a height of the initial window;
identifying D₂ tokens in each intermediate window, excluding those tokens located in a first column of each intermediate window, having a lowest information content;
merging each of the D₂ tokens in each intermediate window into another token in that intermediate window in a horizontal direction to transform each intermediate window into a corresponding spatially complete window having a width that is D₂ smaller than a width of the initial window and the intermediate window.

14. The system of claim 13, further comprising:
identifying D₃ tokens in each spatially complete window, excluding those tokens located in a first temporal plane of each spatially complete window, having a lowest information content;
merging each of the D₃ tokens in each spatially complete window into another token in that spatially complete window in a temporal direction to transform each spatially complete window into a tempo-spatially complete window having a time that is D₃ shorter than a time of the initial windows, the intermediate window, and the spatially complete window.

15. A non-transitory computer readable storage device, including instructions that, when executed by a processor, perform operations that include:
receiving input data into a Swin transformer model;
processing the input data in the Swin transformer model to obtain tokens for a tokenized input;
selecting a pruning method for the input data from:
removing;
packaging; and
merging;
pruning the tokens using a token pruning module, which performs the selected token pruning method; and
outputting pruned data.

16. The device of claim 15, wherein the selected pruning method is removing, and removing comprises:
identifying windows into which the tokenized input is divided and a pruning target;
identifying N tokens in each window having a lowest information content, where an area of each window is N greater than an area for each window to meet the pruning target;
removing the N tokens from each window to achieve the pruning target with remaining tokens in each window; and
reintegrating each of the windows from the remaining tokens therein.

17. The device of claim 16, wherein the reintegrated window maintains a relative order of the remaining tokens in each window from before pruning to after pruning.

18. The device of claim 15, wherein the selected pruning method is packaging, and packaging comprises:
identifying windows into which the tokenized input is divided and a pruning target;
identifying P tokens in each window having a lowest information content, where an area of each window is P−1 greater than an area for each window to meet the pruning target;
removing the P tokens from each window;
combining the P removed tokens to produce a packaged token for each window from the P removed tokens from that window; and
reintegrating each of the windows from remaining tokens therein and the packaged token.

19. The device of claim 15, wherein the selected pruning method is merging, and merging comprises:
identifying initial windows into which the tokenized input is divided and a pruning target;
identifying D₁ tokens in each initial window, excluding those tokens located in a first row of each initial window, having a lowest information content;
merging each of the D₁ tokens in each initial window into another token in that initial window in a vertical direction to transform each initial window into a corresponding intermediate window having a height that is D₁ smaller than a height of the initial window;
identifying D₂ tokens in each intermediate window, excluding those tokens located in a first column of each intermediate window, having a lowest information content;
merging each of the D₂ tokens in each intermediate window into another token in that intermediate window in a horizontal direction to transform each intermediate window into a corresponding spatially complete window having a width that is D₂ smaller than a width of the initial window and the intermediate window.

20. The device of claim 19, further comprising:
identifying D₃ tokens in each spatially complete window, excluding those tokens located in a first temporal plane of each spatially complete window, having a lowest information content;
merging each of the Ds tokens in each spatially complete window into another token in that spatially complete window in a temporal direction to transform each spatially complete window into a tempo-spatially complete window having a time that is Ds shorter than a time of the initial window, the intermediate window, and the spatially complete window.
